(19) United States
(12) Patent Application Publication
(10) Pub. No.: US 2009/0303223 A1
(43) Pub. Date: Dec. 10, 2009

(54) METHOD FOR DRIVING PLASMA DISPLAY PANEL

(75) Inventors: Kosuke Makino, Osaka (JP); Yoshiki Tsujita, Osaka (JP); Kunihiro Mima, Kyoto (JP); Kenji Sasaki, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/296,187

(22) PCT Filed: Feb. 25, 2008
(86) PCT No.: PCT/JP2008/000323

§ 371 Date: Oct. 6, 2008

(30) Foreign Application Priority Data
Feb. 27, 2007 (JP) 2007-046486

(51) Int. Cl. G06F 3/038

(52) U.S. Cl. 345/213; 345/60

(57) ABSTRACT

A method for driving a plasma display panel including a plurality of discharge cells each having a scan electrode and a sustain electrode. One field includes a plurality of subfields each having an address period for generating address discharge in a discharge cell, and a sustain period for alternately applying a sustain pulse to the scan electrode and the sustain electrode to generate sustain discharge in the discharge cell in which the address discharge has been generated. The sustain pulse includes a first sustain pulse rising gently and a second sustain pulse rising more steeply than the first sustain pulse. At least one of the sustain pulses applied secondly and thirdly to the scan electrode is the second sustain pulse, and at least one of the sustain pulses applied secondly and thirdly to the sustain electrode is the second sustain pulse.

### TECHNICAL FIELD

The present invention relates to a method for driving a plasma display panel used in a wall-mounted television and a large-size monitor.

### BACKGROUND ART

An AC surface discharge panel as a typical plasma display panel (hereinafter, abbreviated as a “panel”) includes a front panel and a rear panel disposed facing each other with a large number of discharge cells provided therebetween.

The front panel has a plurality of display electrode pairs each including a scan electrode and a sustain electrode formed in parallel to each other on a front glass substrate. The rear panel has a plurality of data electrodes in parallel to each other on a rear glass substrate. The front panel and the rear panel are disposed facing each other so that the display electrode pairs three-dimensionally intersect with the data electrodes, and sealed with each other. In discharge space inside thereof, a discharge gas is filled. Herein, a discharge cell is formed in a part where the display electrode pair and the data electrode face each other.

As a method for driving a panel, a subfield method is generally used. The subfield method includes dividing one field period into a plurality of subfields and carrying out gradation display by a combination of subfields to emit light. Each subfield includes an initialization period, an address period, and a sustain period. In the initialization period, initialization discharge is generated so as to form wall charge necessary for the subsequent address operation on each electrode. In the address period, address discharge is generated selectively so as to form wall charge in a discharge cell to be displayed. Then, in the sustain period, sustain pulses are alternately applied to the display electrode pair so as to generate sustain discharge in a discharge cell in which address discharge has been made and allow a phosphor layer of the corresponding discharge cell to emit light. Thus, an image is displayed.

As a circuit for applying a sustain pulse to the display electrode pair, a so-called electric power recovery circuit capable of reducing power consumption is generally used (see, for example, patent document 1). Patent document 1 discloses an electric power recovery circuit by focusing on the fact that each of the display electrode pair is a capacitive load having an inter-electrode capacity of the display electrode pair, LC-resonating an inductor and the inter-electrode capacity by using a resonance circuit including the inductor as a component, recovering electric charges stored in the inter-electrode capacity, and reusing the collected electric charges for driving the display electrode pair.

On the other hands, according to the recent trend toward a larger screen and higher definition of a panel, various efforts to improve the light emission efficiency of the panel and to improve the brightness have been carried out. For example, studies have been carried out for largely enhancing the light emission efficiency by increasing the partial pressure of xenon. However, if the partial pressure of xenon is increased, variation in timing for generating discharge is increased. As a result, variation occurs in the light emission intensity for each discharge cell, which may cause ununiformity in display brightness. In order to address the problem of ununiformity in brightness, there is disclosed, for example, a driving method for making the display brightness uniform by inserting a steeply rising sustain pulse once in plural times so as to adjust the timing of the sustain discharge (see, for example, patent document 2).

Furthermore, when a partial pressure of xenon is increased, in a case where a still image and the like is displayed for a long time and then an image having a high brightness is displayed, the still image may be recognized as an after-image. Consequently, the quality of an image display may be damaged. In order to reduce such an after-image phenomenon, there is disclosed a method for suppressing the deterioration of the quality of image display by moving a display position of the image in which an after-image tends to occur (see, for example, patent document 3).

According to the method described in patent document 3, although the degree of recognition of an after-image is somewhat relieved, the after-image phenomenon itself is not reduced. Furthermore, since image processing, for example, processing of moving a display position of an image is carried out together, there has been a possibility that images are not displayed faithfully.

[Patent document 1] Japanese Patent Examined Publication No. H7-109542

[Patent document 2] Japanese Patent Unexamined Publication No. 2005-338120

[Patent document 3] Japanese Patent Unexamined Publication No. H8-248934

### SUMMARY OF THE INVENTION

The present invention provides a method for driving a panel including a plurality of discharge cells each having a scan electrode and a sustain electrode. In the method, one field includes a plurality of subfields each having an address period for generating address discharge in a discharge cell, and a sustain period for alternately applying a sustain pulse to the scan electrode and the sustain electrode to generate sustain discharge in the discharge cell in which the address discharge has been generated. The sustain pulse includes a first pulse rising gently and a second sustain pulse rising more steeply than the first sustain pulse. At least one of the sustain pulse applied secondly to the scan electrode and the sustain pulse applied thirdly to the scan electrode is the second sustain pulse, and at least one of the sustain pulse applied secondly to the sustain electrode and the sustain pulse applied thirdly to the sustain electrode is the second sustain pulse.

With this method, it is possible to provide a method for driving a panel, which is capable of reducing an after-image phenomenon itself while faithful image is displayed and which is capable of making the display brightness of the discharge cells uniform.

Furthermore, according to the method for driving a panel of the present invention, the sustain pulse applied thirdly to the scan electrode may be the second sustain pulse.

Furthermore, according to the method for driving a panel of the present invention, the sustain pulse applied secondly to the scan electrode and the sustain pulse applied secondly to the sustain electrode may be the second sustain pulse.

Furthermore, according to the method for driving a panel of the present invention, the second sustain pulse may be applied, excluding a predetermined number of sustain pulses from an end of the sustain period.

Furthermore, according to the method for driving a panel of the present invention, two continuous sustain pulses among four continuous sustain pulses from a p-th (p is an integer of 3 or more) sustain pulse to a (p+3)-th sustain pulse in the sustain period sequentially applied to the scan electrode and the sustain electrode may be the second sustain pulse.

Furthermore, according to the method for driving a panel of the present invention, two continuous sustain pulses excluding two continuous second sustain pulses may be the first sustain pulse.

### BRIEF DESCRIPTION OF THE DRAWINGS

FIG. 1 is an exploded perspective view showing a structure of a panel in accordance with a first exemplary embodiment of the present invention.

FIG. 2 is a view showing an arrangement of electrodes of the panel.

FIG. 3 is a waveform diagram of a driving voltage applied to each electrode of the panel.

FIG. 4A is a view showing a detail of a first sustain pulse in accordance with a first exemplary embodiment of the present invention.

FIG. 4B is a view showing a detail of a second sustain pulse in accordance with a first exemplary embodiment of the present invention.

FIG. 5A is a view showing an example of sustain pulses applied to a scan electrode and a sustain electrode in a sustain period in accordance with the first exemplary embodiment of the present invention.

FIG. 5B is a view showing an example of sustain pulses applied to a scan electrode and a sustain electrode in a sustain period in accordance with the first exemplary embodiment of the present invention.

FIG. 5C is a view showing another example of sustain pulses applied to a scan electrode and a sustain electrode in a sustain period in accordance with the first exemplary embodiment of the present invention.

FIG. 5D is a view showing a further example of sustain pulses applied to a scan electrode and a sustain electrode in a sustain period in accordance with the first exemplary embodiment of the present invention.

FIG. 6 is a circuit block diagram of a plasma display device in accordance with the first exemplary embodiment of the present invention.

FIG. 7 is a circuit diagram showing a sustain pulse generating circuit in accordance with the first exemplary embodiment of the present invention.

FIG. 8A is a view to illustrate an operation of the sustain pulse generating circuit.

FIG. 8B is a view to illustrate an operation of the sustain pulse generating circuit.

FIG. 9 is a view showing an example of sustain pulses applied to a scan electrode and a sustain electrode in a sustain period in accordance with a second exemplary embodiment of the present invention.

### REFERENCE MARKS IN THE DRAWINGS

10 panel

22 scan electrode

23 sustain electrode

24 display electrode pair

32 data electrode

41 image signal processing circuit

42 data electrode driving circuit

43 scan electrode driving circuit

44 sustain electrode driving circuit

45 timing generating circuit

50, 60 sustain pulse generating circuit

52, 62 power recovery portion

56, 66 clamping portion

100 plasma display device

A first sustain pulse

B second sustain pulse

### DETAILED DESCRIPTION OF THE PREFERRED EMBODIMENTS

Hereinafter, a method for driving a panel in accordance with exemplary embodiments of the present invention is described with reference to drawings.

### First Exemplary Embodiment

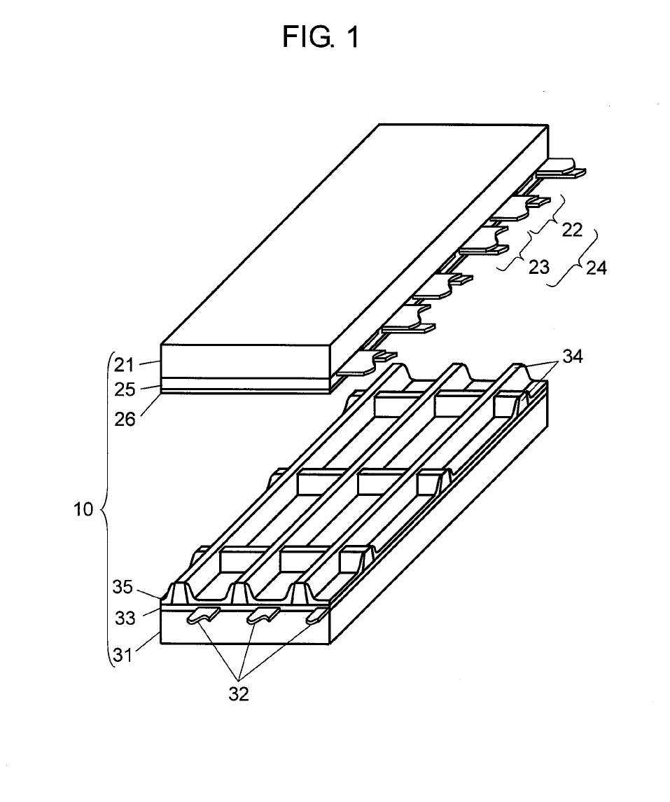

FIG. 1 is an exploded perspective view showing a structure of panel 10 in accordance with a first exemplary embodiment of the present invention. On glass front substrate 21, a plurality of display electrode pairs 24 each composed of scan electrode 22 and sustain electrode 23 are formed. Then, dielectric layer 25 is formed so as to cover display electrode pair 24, and protective layer 26 is formed on dielectric layer 25. A plurality of data electrodes 32 are formed on rear panel 31, dielectric layer 33 is formed so as to cover data electrodes 32, and double-cross-shaped barrier ribs 34 are formed thereon. On the side surface of barrier ribs 34 and on the surface of dielectric layer 33, phosphor layer 35 that emits red, green or blue light is provided.

Front panel 21 and rear panel 31 are disposed facing each other so that display electrode pairs 24 and data electrodes 32 intersect with each other with extremely small discharge space interposed therebetween. Front panel 21 and rear panel 31 are sealed to each other on peripheral portions thereof with a sealing agent such as glass frit. The discharge space is filled with, for example, a mixture gas including, for example, neon and xenon as a discharge gas. The discharge space is partitioned into plural sections by barrier ribs 34. A discharge cell is formed in a portion where display electrode pair 24 crosses data electrode 32. These discharge cells discharge and emit light so as to display an image.

The structure of panel 10 is not limited to that described above, but it may be provided with stripe barrier ribs, for example.

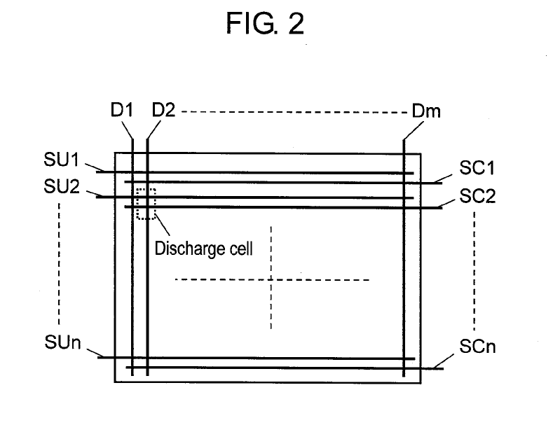

FIG. 2 is an arrangement diagram of electrodes on panel 10 in accordance with the first embodiment of the present invention. Panel 10 has n pieces of scan electrodes SC1-SCn (scan electrode 22 in FIG. 1) and n pieces of sustain electrodes SU1-SUn (sustain electrode 23 in FIG. 1), which are long in the row direction, and m pieces of data electrodes D1-Dm (data electrode 32 in FIG. 1) that are long in the column direction. A discharge cell is formed in a portion where a pair of scan electrode SCi (i=1 to n) and sustain electrode SUi (i=1 to n) crosses one data electrode Dj (j=1 to m). M×n pieces of discharge cells in total are formed in the discharge space. As shown in FIGS. 1 and 2, scan electrode SCi and sustain electrode SUi are formed in pairs, parallel to each other, thus providing inter-electrode capacity Cp between scan electrodes SC1-SCn and sustain electrodes SU1-SUn.

Next, a driving voltage waveform for driving panel 10 and its operation are described. The plasma display device displays gradation by a subfield method, in which one field period is divided into plural subfields, and light emission/non-emission of each discharge cell is controlled for every subfield. Each subfield has an initialization period, an address period, and a sustain period. In the initialization period, initialization discharge is generated to form wall charge necessary for the subsequent address discharge on each electrode. In the address period, address discharge is generated selectively in a discharge cell to emit light, forming wall charge. In the sustain period, sustain pulses are alternately applied to a display electrode pair to generate sustain discharge in a discharge cell in which address discharge has been generated, thus emitting light. The number of the sustain pulses is a number obtained by multiplying a brightness weight by brightness scale factor.

In this exemplary embodiment, one field is divided into ten subfields (first SF, second SF, . . . , and tenth SF), and the subfields are assumed to have brightness weights of (1, 2, 3, 6, 11, 18, 30, 44, 60, and 80), for example. Furthermore, an initialization operation is assumed to be carried out in all discharge cells in the initialization period of the first SF, and an initialization operation is assumed to be carried out selectively in a discharge cell in which sustain discharge has been generated in the initialization period of the second to tenth SFs. However, the present invention does not limit the number of subfields or the brightness weight of each subfield to the above-described value.

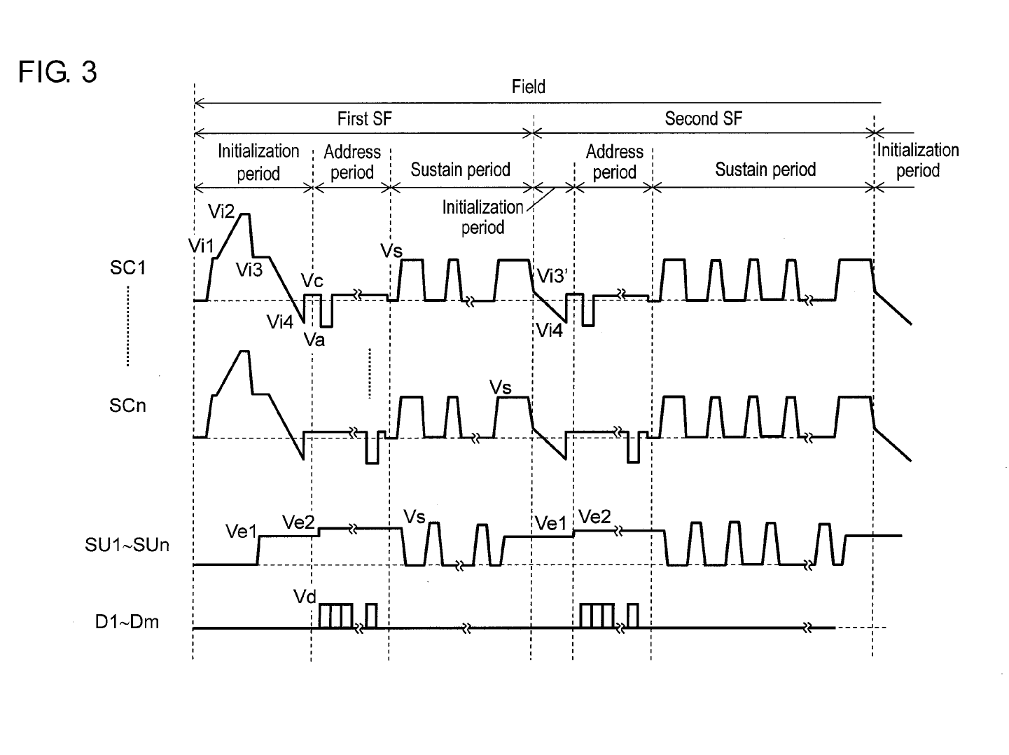

FIG. 3 is a waveform diagram of a driving voltage applied to each electrode of panel 10 in accordance with the first exemplary embodiment of the present invention. FIG. 3 shows driving voltage waveforms of two subfields but driving voltage waveforms in other subfields are also substantially the same.

In the first half of the initialization period of the first SF, a voltage of 0 (V) is applied to data electrodes D1-Dm and sustain electrodes SU1-SUn, respectively, and a gradient waveform voltage gently rising from voltage Vi1, not higher than the discharge start voltage with respect to sustain electrodes SU1-SUn, toward voltage Vi2, higher than the discharge start voltage, is applied to scan electrodes SC1-SCn. While this gradient waveform voltage rises, feeble initialization discharge occurs between scan electrodes SC1-SCn and sustain electrodes SU1-SUn, and between scan electrodes SC1-SCn and data electrodes D1-Dm, respectively. Then, a negative wall voltage accumulates on scan electrodes SC1-SCn, and a positive wall voltage accumulates on data electrodes D1-Dm and sustain electrodes SU1-SUn. Herein, a wall voltage on the electrode refers to a voltage generated by wall charge accumulated on a dielectric layer, a protective layer, a phosphor layer, and others covering the electrodes.

In the latter half of the initialization period, positive voltage Ve1 is applied to sustain electrodes SU1-SUn, and a gradient waveform voltage gently decreasing from voltage Vi3, not higher than the discharge start voltage with respect to sustain electrodes SU1-SUn, toward voltage Vi4, higher than the discharge start voltage, is applied to scan electrodes SC1-SCn. During this time, feeble initialization discharge occurs between scan electrodes SC1-SCn and sustain electrodes SU1-SUn, and between scan electrodes SC1-SCn and data electrodes D1-Dm, respectively. Then, the negative wall voltage on scan electrodes SC1-SCn and the positive wall voltage on sustain electrodes SU1-SUn are weakened, and the positive wall voltage on data electrodes D1-Dm is adjusted to a value suitable for an address operation. Thus, the initialization operation is completed.

As the driving voltage waveform in the initialization period, as shown in the initialization period of the second SF in FIG. 3, only the voltage waveform in the latter half of the initialization period may be applied. In this case, initialization discharge selectively occurs in the discharge cell in which sustain discharge has been carried out in the sustain period of the immediately preceding subfield.

In the subsequent address period, firstly, voltage Ve2 is applied to sustain electrodes SU1-SUn, and voltage Vc is applied to scan electrodes SC1-SCn.

Next, while negative scan pulse Va is applied to scan electrode SCI in the first row, positive address pulse Vd is applied to data electrode Dk (k=1 to m) of a discharge cell to emit light in the first row among data electrodes D1-Dm. At this time, a voltage difference in the intersection between on data electrode Dk and on scan electrode SC1 results in difference (Vd−Va) of externally applied voltages with the difference between the wall voltages on data electrode Dk and on scan electrode SC1 added, which exceeds the discharge start voltage. Then, address discharge occurs between data electrode Dk and scan electrode SC1, and between sustain electrode SU1 and scan electrode SC1; a positive wall voltage accumulates on scan electrode SC1; and a negative wall voltage accumulates on sustain electrode SU1 as well as on data electrode Dk.

In this way, the address operation is carried out in which address discharge is generated in a discharge cell to emit light in the first row so as to accumulate a wall voltage on each electrode. Meanwhile, since the voltage at intersections of data electrodes D1-Dm to which address pulse voltage Vd has not been applied and scan electrode SC1 does not exceed the discharge start voltage, address discharge is not generated. The above-described address operation is carried out in all the way to the discharge cell in the n-th row of scan electrode SCn. Thus, the address period is completed.

In the subsequent sustain period, in this exemplary embodiment, the gently rising first sustain pulse and the steeply rising second sustain pulse are applied to scan electrodes SC1-SCn and sustain electrodes SU1-SUn, respectively, thus generating sustain discharge in a discharge cell in which address discharge has been generated. The detail of the sustain pulse is described later. Firstly, an outline of the operation in the sustain period is described.

In the sustain period, firstly, positive sustain pulse voltage Vs is applied to scan electrodes SC1-SCn, and a voltage of 0 (V) is applied to sustain electrodes SU1-SUn. Then, in a discharge cell in which address discharge has been generated, the difference between a voltage on scan electrode SCi and that on sustain electrode SUi results in a voltage obtained by adding the difference between the wall voltage on scan electrode SCi and that on sustain electrode SUi to sustain pulse voltage Vs, which exceeds the discharge start voltage. Then, sustain discharge occurs between scan electrode SCi and sustain electrode SUi, and ultraviolet light generated at this time allows phosphor layer 35 to emit light. Then, a negative wall voltage accumulates on scan electrode SCi, and a positive wall voltage accumulates on sustain electrode SUi. Furthermore, a positive wall voltage accumulates on data electrode Dk as well. In a discharge cell in which address discharge has not occurred in the address period, sustain discharge has not occurred and the wall voltage at the end of the initialization period is maintained.

Subsequently, a voltage of 0 (V) is applied to scan electrodes SCI-SCn, and sustain pulse Vs is applied to sustain electrodes SU1-SUn, respectively. Then, since a difference between the voltage on sustain electrode SUi and that on scan electrode SCi exceeds the discharge start voltage in a discharge cell in which sustain discharge has been generated, sustain discharge occurs between sustain electrode SUi and scan electrode SCi again. Consequently, a negative wall voltage accumulates on sustain electrode SUi, and a positive wall voltage accumulates on scan electrode SCi.

In the same way since then, sustain pulses of the number corresponding to the brightness weight are applied alternately to scan electrodes SC1-SCn and sustain electrodes SU1-SUn so as to provide potential difference between the electrodes of the display electrode pair. Thus, sustain discharge is continued to be generated in a discharge cell in which address discharge has been generated in the address period.

At the end of the sustain period, a so-called narrow-width pulse-like potential difference is applied between scan electrodes SC1-SCn and sustain electrodes SU1-SUn, thereby erasing the wall voltage on scan electrode SCi and on sustain electrode SUi with the positive wall voltage on data electrode Dk remained. Thus, the sustain operation in the sustain period is completed.

Since an operation in the subsequent subfield is substantially the same as the operation of the first SF, description thereof is omitted.

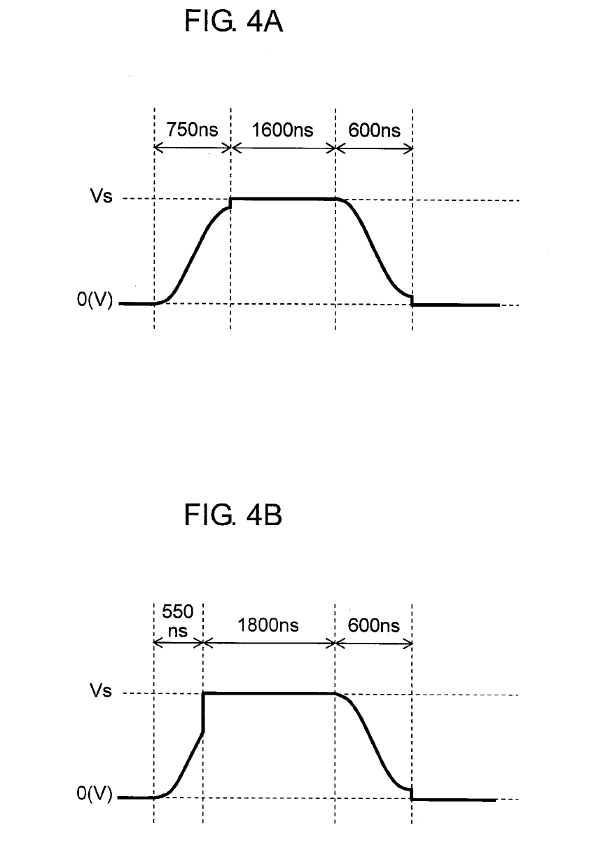

Next, the detail of the sustain pulse is described. FIGS. 4A and 4B show the detail of the sustain pulse in accordance with the first exemplary embodiment of the present invention, respectively. FIG. 4A shows first sustain pulse A rising gently, and FIG. 4B shows second sustain pulse B rising more steeply than first sustain pulse A. In this exemplary embodiment, in first sustain pulse A, the rising time is 750 ns, the pulse sustaining time is 1600 ns, and the falling time is 600 ns. Furthermore, second sustain pulse B rises more steeply than first sustain pulse A, in this exemplary embodiment, the rising time is 550 ns, the pulse sustaining time is 1800 ns and the falling time is 600 ns. Note here that the rising time is not particularly limited to these values. It is important that second sustain pulse B rises more steeply than first sustain pulse A. That is to say, the sustain pulse includes at least first sustain pulse A rising gently and second sustain pulse B rising more steeply than first sustain pulse A.

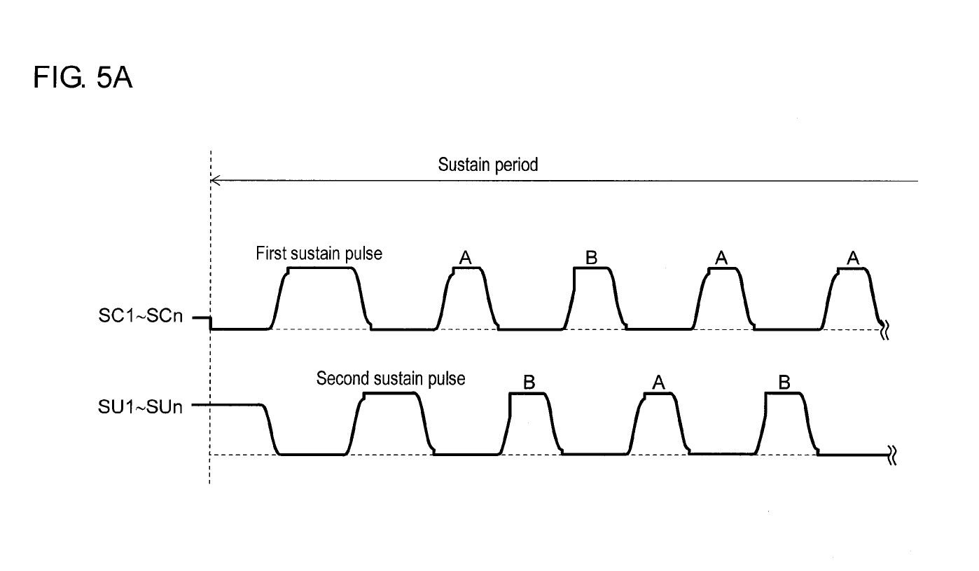

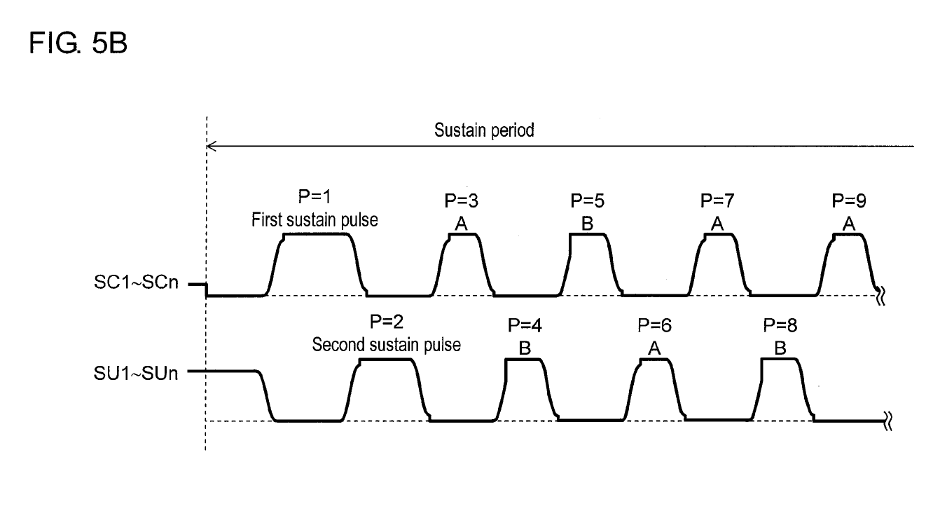

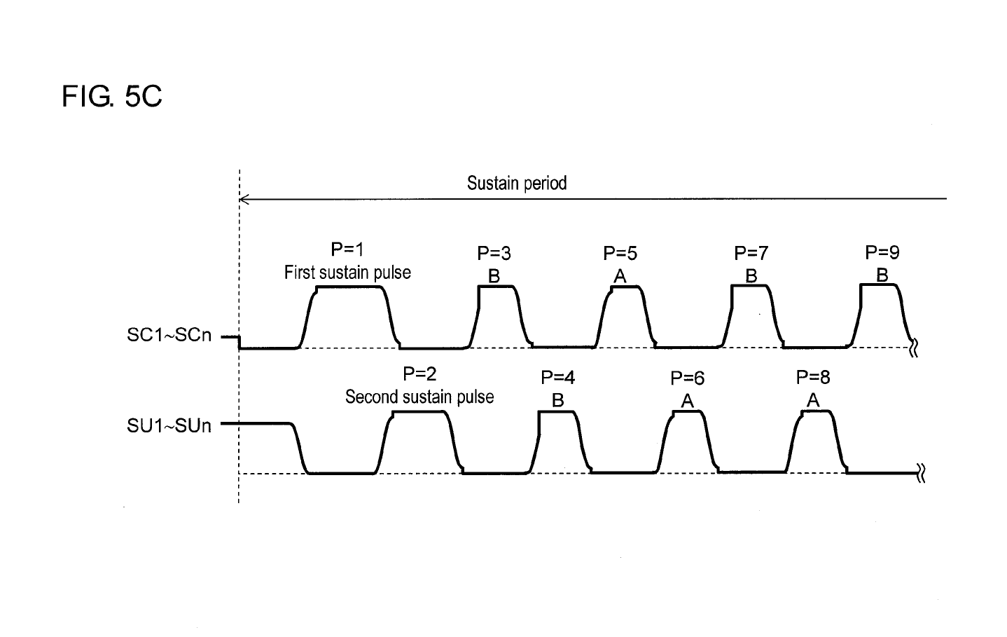

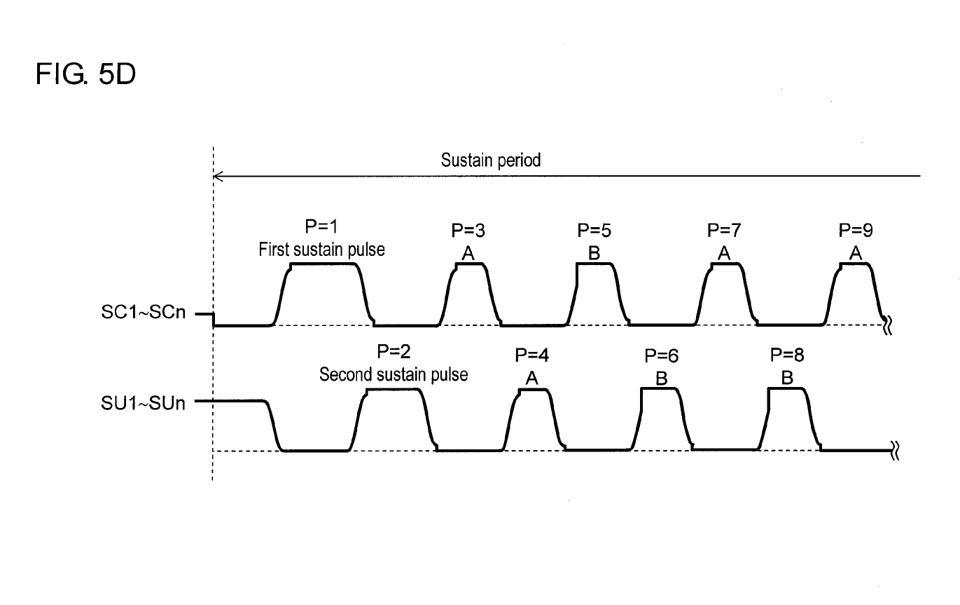

FIG. 5A is a view showing an example of sustain pulses applied to scan electrodes SC1-SCn and sustain electrodes SU1-SUn in the sustain period in accordance with the first exemplary embodiment of the present invention. FIG. 5A shows that first sustain pulse A and second sustain pulse B are applied to scan electrodes SCI-SCn and sustain electrodes SU1-SUn, respectively. In this exemplary embodiment, a first sustain pulse in the sustain period, that is, a sustain pulse applied firstly to scan electrodes SC1-SCn rises gently. Furthermore, this sustain pulse has a sustaining time longer than that of first sustain pulse A and second sustain pulse B. Furthermore, a second sustain pulse in the sustain period, that is, a sustain pulse applied firstly to sustain electrodes SU1-SUn also rises gently. Furthermore, this sustain pulse has a sustaining time longer than that of first sustain pulse A and second sustain pulse B.

In this way, the first sustain pulse among the sustain pulses applied to scan electrodes SC1-SCn and the first sustain pulse among the sustain pulses applied to sustain electrodes SU1-SUn have a long pulse sustaining time. The reason for this is mentioned below. A considerably long time has elapsed before the discharge cell, in which a scanning pulse has been applied to scan electrode SC1 of the first row so as to carry out address discharge, generates the first sustain discharge. Therefore, priming generated by the address discharge is attenuated and the priming becomes short in the first sustain discharge, and the discharge delay time may tend to be increased. The same is true in discharge cells in which address discharge is carried out by applying a scanning pulse to the scan electrodes SC2, SC3, . . . of the second row and the third row . . . However, in this exemplary embodiment, since the pulse sustaining time of the first sustain pulse is set to be long, even if the discharge cell has a long discharge delay time, a sustain discharge can be generated stably. The reason why the pulse sustaining time of the sustain pulse applied firstly to the sustain electrode is long is the same. Even in a discharge cell in which a sufficient priming has not been generated in the first sustain discharge, the sustain discharge is generated stably.

Then, in this exemplary embodiment, the third sustain pulse in the sustain period, that is, a sustain pulse applied secondly to scan electrodes SC1-SCn is gently rising first sustain pulse A. The fourth sustain pulse in the sustain period, that is, a sustain pulse applied secondly to sustain electrodes SU1-SUn is steeply rising second sustain pulse B. The fifth sustain pulse in the sustain period, that is, a sustain pulse applied thirdly to scan electrodes SC1-SCn is second sustain pulse B; the sixth sustain pulse in the sustain period, that is, a sustain pulse applied thirdly to sustain electrodes SU1-SUn is first sustain pulse A. Then, the seventh sustain pulse in the sustain period is first sustain pulse A and the eighth sustain pulse in the sustain period is second sustain pulse B.

Since then, first sustain pulse A, second sustain pulse B, second sustain pulse B, first sustain pulse A, first sustain pulse A, second sustain pulse B, . . . , are continued.

The sustain pulse of this exemplary embodiment is characterized in that at least one of the sustain pulses applied secondly and thirdly to scan electrodes SC1-SCn is second sustain pulse B and at least one of the sustain pulses applied secondly and thirdly to sustain electrodes SU1-SUn is second sustain pulse B. In the sustain pulses applied secondly and thirdly to scan electrodes SC1-SCn and sustain pulses applied secondly and thirdly to sustain electrodes SU1-SUn, second sustain pulses B is applied continuously. In this exemplary embodiment, the sustain pulse applied secondly to sustain electrodes SU1-SUn and the subsequent sustain pulse applied thirdly to scan electrodes SC1-SCn are second sustain pulse B.

The present inventors have experimentally found that when first sustain pulse A and second sustain pulse B are applied to scan electrodes SC1-SCn and first sustain pulse A and second sustain pulse B are applied also to sustain electrodes SU1-SUn so as to generate discharge, it is possible to reduce an after-image phenomenon and to make the display brightness of discharge cells uniform. Then, the effect can be increased when second sustain pulse B is continuously applied to scan electrodes SC1-SCn and sustain electrodes SU1-SUn. That is to say, at least one of the sustain pulses applied secondly and thirdly to scan electrodes SC1-SCn is second sustain pulse B and at least one of the sustain pulses applied secondly and thirdly to sustain electrodes SU1-SUn is second sustain pulse B. The present inventors have found that the effect can be increased when second sustain pulse B is continuously applied in sustain pulses applied secondly and thirdly to scan electrodes SC1-SCn and sustain pulses applied secondly and thirdly to sustain electrodes SU1-SUn.

The light emission intensity is affected by the state of a wall charge in the discharge cell. In order to make the wall charges uniform, it is thought to be effective to generate sustain discharge while the intensity is changed from the beginning of the sustain period. However, the state of the wall charge is not easily changed by changing the intensity of the sustain discharge only once. Therefore, as mentioned above, it is thought that second sustain pulse B and first sustain pulse A are generated continuously, thereby reducing the after-image phenomenon.

The number of first sustain pulses A and second sustain pulses B to be applied is desired to be set suitably according to whether the generated after-image is positive or negative and according to the intensity of the generated after-image. However, it becomes clear that the after-image itself can be reduced and the display brightness of the discharge cells can be made uniform by generating first sustain pulse A and second sustain pulse B continuously.

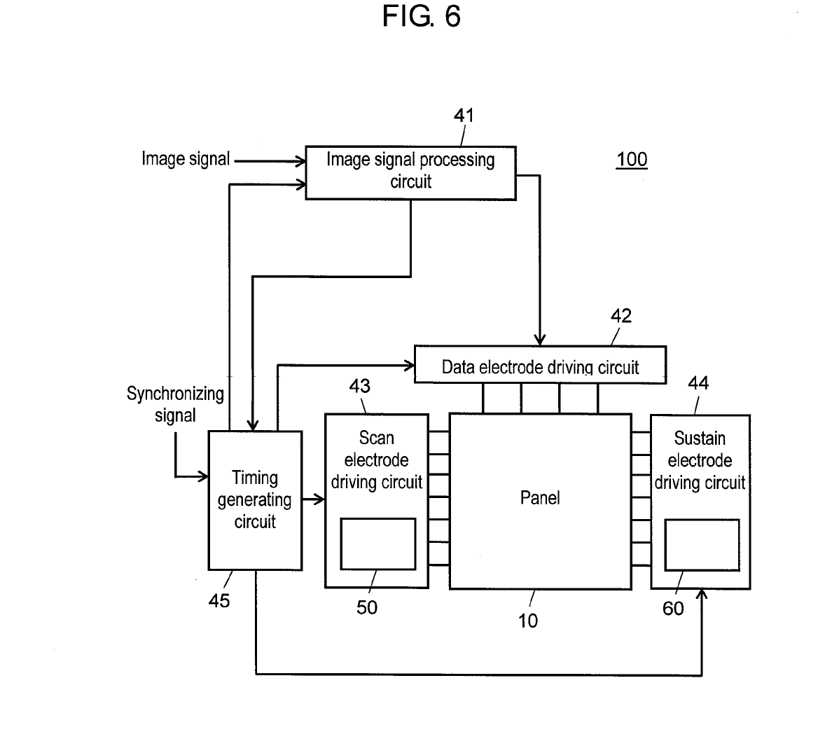

Next, a driving circuit for operating panel 10 and its operation are described. FIG. 6 is a circuit block diagram showing plasma display device 100 in accordance with the first exemplary embodiment of the present invention. Plasma display device 100 includes panel 10, image signal processing circuit 41, data electrode driving circuit 42, scan electrode driving circuit 43, sustain electrode driving circuit 44, timing generating circuit 45 and a power supply circuit (not shown) for supplying power necessary for each circuit block.

Image signal processing circuit 41 converts input image signals into image data indicating emission/non-emission for every subfield. Data electrode driving circuit 42 converts image data for every subfield into a signal corresponding to each of data electrodes D1-Dm so as to drive each of data electrodes D1-Dm.

Timing generating circuit 45 generates various types of timing signals for controlling the operation of each circuit block on the basis of a horizontal synchronizing signal and a vertical synchronizing signal to supply each circuit block. Scan electrode driving circuit 43 includes sustain pulse generating circuit 50 for generating sustain pulses to be applied to scan electrodes SC1-SCn in the sustain period, thus driving respective scan electrodes SC1-SCn on the basis of timing signals. Sustain electrode driving circuit 44 includes sustain pulse generating circuit 60 for generating sustain pulses to be applied to sustain electrodes SU1-SUn in the sustain period, thus driving sustain electrodes SU1-SUn on the basis of timing signals.

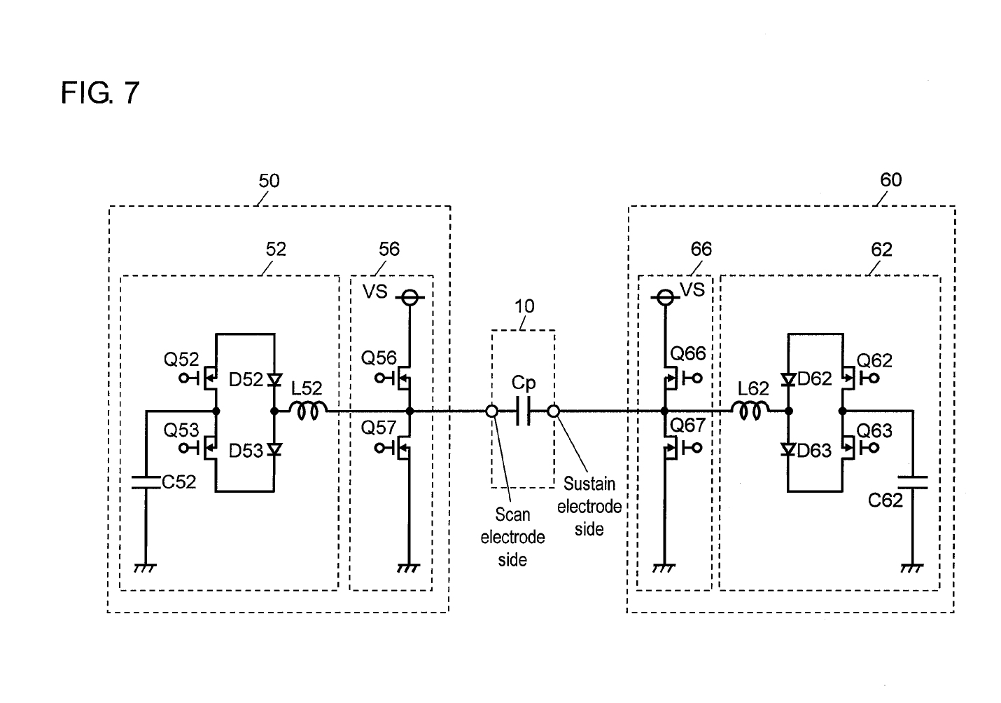

Next, the details of sustain pulse generating circuits 50 and 60 and the operation thereof are described. FIG. 7 is a circuit diagram showing sustain pulse generating circuits 50 and 60 in accordance with the first exemplary embodiment of the present invention. In FIG. 7, inter-electrode capacity of panel 10 is denoted by Cp, and a circuit for generating a scanning pulse to be applied to scan electrodes SC1-SCn and an initialization voltage waveform is omitted. Furthermore, in FIG. 7, a circuit for generating voltages Ve1 and Ve2 to be applied to sustain electrodes SU1-SUn is also omitted.

Sustain pulse generating circuit 50 includes power recovery portion 52 and clamping portion 56. Power recovery portion 52 includes capacitor C52 for recovering electric power, switching elements Q52 and Q53, back flow preventing diodes D52 and D53, and resonance inductor L52. Inter-electrode capacity Cp and inductor L52 are LC-resonated, and rising and falling of a sustain pulse are carried out. Therefore, power consumption is reduced.

Clamping portion 56 includes switching element Q56 for clamping scan electrodes SCI-SCn to electric power VS having a voltage value of Vs, and switching element Q57 for clamping scan electrodes SC1-SCn to a ground potential. Then, since clamping is carried out with respect to electric power VS or 0 (V) via these switching elements, it is possible to reduce the impedance at the time when the voltage is applied and to allow a large discharge electric current to flow stably.

Power recovery portion 52 and clamping portion 56 are coupled to scan electrodes SC1-SCn, that is, one end of the inter-electrode capacity Cp in panel 10, via a scan pulse generating circuit (not shown in this drawing because it is in a state of short circuit during the sustain period). Note here that capacitor C52 for recovering electric power has capacity that is sufficiently larger than inter-electrode capacity Cp and is charged to about Vs/2 that is half of voltage value Vs of electric power VS so that it works as electric power of power recovery portion 52. Furthermore, these switching elements can be constructed by using generally known elements such as MOSFET, IGBT, and the like.

Sustain pulse generating circuit 60 includes power recovery portions 62 having capacitor C62 for recovering electric power, switching elements Q62 and Q63, back flow preventing diodes D62 and D63 and resonance inductor L62; and clamping portion 66 having switching element Q66 for clamping sustain electrodes SU1-SUn to voltage Vs, and switching element Q67 for clamping sustain electrodes SU1-SUn to a ground potential. Sustain pulse generating circuit 60 is coupled to sustain electrodes SU1-SUn, that is, one end of inter-electrode capacity Cp of panel 10.

In this exemplary embodiment, inductors L52 and L62 are set so that the LC resonance cycle of inductor L52 and inter-electrode capacity Cp of panel 10 (hereinafter, referred to as “resonance cycle”) and the resonance cycle of inductor L62 of power recovery portion 62 and inter-electrode capacity Cp thereof are about 1700 nsec.

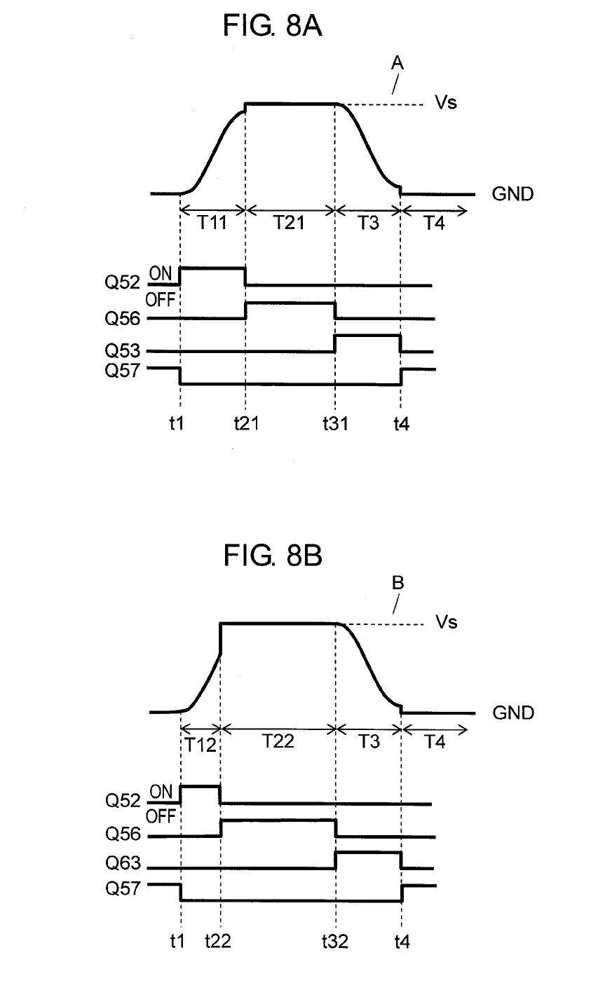

Next, an operation of sustain pulse generating circuit 50 is described. FIGS. 8A and 8B are views to illustrate an operation of sustain pulse generating circuit 50 in accordance with the first exemplary embodiment of the present invention. FIG. 8A shows a waveform of first sustain pulse A, and FIG. 8B shows a waveform of second sustain pulse B. Furthermore, FIGS. 8A and 8B show how switching elements Q52, Q53, Q56 and Q57 operate in order to generate these waveform diagrams. Herein, sustain pulse generating circuit 50 is described herein, but the same is true in the operation of sustain pulse generating circuit 60.

Firstly, first sustain pulse A shown in FIG. 8A is described.

### (Period T11)

Switching element Q52 is turned ON at time t1. Then, electric charge starts to move from capacitor C52 for recovering electric power to scan electrodes SC1-SCn via switching element Q52, diode D52, and inductor L52, and thus voltages of scan electrodes SC1-SCn start to rise. Since inductor L52 and inter-electrode capacity Cp form a resonance circuit, voltages of scan electrodes SCI-SCn rise to about Vs at the time after ½ of the resonance cycle has elapsed from time t1.

### (Period T21)

In first sustain pulse A, switching element Q56 is turned ON at time t21 a little before the time of ½ of the resonance cycle has elapsed from time t1. Then, scan electrodes SCI-SCn are coupled to electric power VS via switching element Q56 and clamped to voltage Vs so as to generate a sustain discharge. Note here that the rise of the sustain pulse applied to scan electrodes SC1-SCn, that is, the time of period T11 from time t1 to time t21, is set to about 750 nsec.

### (Period T3)

Switching element Q53 is turned ON at time t31. Then, electric charge starts to move from scan electrodes SC1-SCn to capacitor C52 via inductor L52, diode D53 and switching element Q53, and thus voltages of scan electrodes SC1-SCn start to decrease. Since inductor L52 and inter-electrode capacity Cp form a resonance circuit, voltages of scan electrodes SC1-SCn decrease to about 0 (V) at the time after about ½ of the resonance cycle has elapsed from time t31.

### (Period T4)

At time t4, switching element Q57 is turned ON. Then, scan electrodes SC1-SCn are grounded via switching element Q57 and clamped to 0 (V).

Next, second sustain pulse B shown in FIG. 8B is described.

### (Period T12)

Switching element Q52 is turned ON at time t1. Then, electric charge starts to move from capacitor C52 for recovering electric power to scan electrodes SC1-SCn via switching element Q52, diode D52, and inductor L52, and thus voltages of scan electrodes SC1-SCn start to rise.

### (Period T22)

In second sustain pulse B, switching element Q56 is turned ON at time t22 before the time of ½ of the resonance cycle elapses from time t1. Then, scan electrodes SC1-SCn are coupled to electric power VS via switching element Q56 and clamped to voltage Vs. Then, in a discharge cell in which address discharge has been generated, a voltage difference between scan electrodes SC1-SCn and sustain electrodes SU1-SUn exceeds a discharge starting voltage and a sustain discharge is generated. In this exemplary embodiment, the resonance cycle of inductor L52 and inter-electrode capacity Cp is set to about 1700 nsec, and the rising of the sustain pulse applied to scan electrodes SC1-SCn, that is, the time of period T12 from time t1 to time t22, is set to about 550 nsec, which is shorter than ½ of the resonance cycle. Furthermore, in second sustain pulse B, period T22 is set to be longer than period T21 by a time corresponding to the rising time that is shorter than that of first sustain pulse A, and the lengths of one cycle from the rising to the falling are the same in first sustain pulse A and second sustain pulse B.

Operations in (Period T3) and (Period T4) are the same as those in first sustain pulse A.

Thus, the rising time of second sustain pulse B is about 550 nsec, which is set to be shorter than ½ of the resonance cycle of inductor L52 and inter-electrode capacity Cp, about 1700 nsec.

In this way, by controlling the time for which switching element Q52 of power recovery portion 52 and switching element Q62 of power recovery portion 62 are sustained ON, two kinds of sustain pulses having different rising are generated. Thus, first sustain pulse A and second sustain pulse B are generated in combination, thereby improving the display quality.

This exemplary embodiment describes a case in which, as shown in FIG. 5A, the sustain pulse applied secondly to sustain electrodes SU1-SUn and the subsequent sustain pulse applied thirdly to scan electrodes SC1-SCn are second sustain pulse B. However, the present invention is not necessarily limited to this case. For example, the sustain pulse applied secondly to scan electrodes SC1-SCn and the subsequent sustain pulse applied secondly to sustain electrodes SU1-SUn may be second sustain pulse B. Furthermore, the sustain pulse applied thirdly to scan electrodes SCI-SCn and the subsequent sustain pulse applied thirdly to sustain electrodes SU1-SUn may be second sustain pulse B.

FIG. 5B is a view showing an example of the sustain pulses applied to scan electrodes SC1-SCn and sustain electrodes SU1-SUn in the sustain period in accordance with this exemplary embodiment. FIG. 5B is a view in which reference numerals “p” denoting the order of the sustain pulses to be applied in the sustain period are added to FIG. 5A in order to make the following description easier. Herein, p is an integer and signifies the order of sustain pulses to be applied to scan electrodes SC1-SCn and sustain electrodes SU1-SUn.

As mentioned above, in this exemplary embodiment, the third sustain pulse (shown by p=3) applied secondly to scan electrodes SC1-SCn in the sustain period is gently rising first sustain pulse A. Furthermore, the fourth sustain pulse (shown by p=4) applied secondly to sustain electrodes SU1-SUn in the sustain period is steeply rising second sustain pulse B. Then, the fifth sustain pulse (shown by p=5) applied thirdly to scan electrodes SC1-SCn in the sustain period is second sustain pulse B. The subsequent sixth sustain pulse (shown by p=6) applied thirdly to sustain electrodes SU1-SUn in the sustain period is first sustain pulse A. Then, the seventh sustain pulse (shown by p=7) in the sustain period is first sustain pulse A. Furthermore, the eighth sustain pulse (shown by p=8) in the sustain period is second sustain pulse B.

Since then, first sustain pulse A (shown by p=9), second sustain pulse B (not shown), second sustain pulse B (not shown), first sustain pulse A (not shown), first sustain pulse A (not shown), second sustain pulse B (not shown) , . . . , are continued.

The sustain pulse applied in the sustain period in the driving method of panel 10 in accordance with this exemplary embodiment is characterized in that at least one of the sustain pulse (shown by p=3) applied secondly to scan electrodes SC1-SCn in the sustain period and the third sustain pulse (shown by p=5) applied thirdly to scan electrodes SC1-SCn in the sustain period is second sustain pulse B, and at least one of the fourth sustain pulse (shown by p=4) applied secondly to sustain electrodes SU1-SUn in the sustain period and the sixth sustain pulse (shown by p=6) applied thirdly to sustain electrodes SU1-SUn in the sustain period is second sustain pulse B, and characterized in that second pulse B is continuously applied in the sustain pulses applied secondly and thirdly to scan electrodes SC1-SCn as well as the sustain pulses applied secondly and thirdly to sustain electrodes SU1-SUn. That is to say, two continuous sustain pulses among the four continuous sustain pulses of the sustain periods (shown by p=3, 4, 5 and 6) are second sustain pulse B.

Thus, a further characteristic of the driving method of panel 10 in this exemplary embodiment is that two continuous sustain pulses among the four continuous sustain pulses from the p-th (p denotes an integer of 3 or more) sustain pulse to the (p+3)-th sustain pulse in the sustain period sequentially applied to scan electrodes SC1-SCn and sustain electrodes SU1-SUn are second sustain pulse B. In this exemplary embodiment, the fourth sustain pulse (shown by p=4 in FIG. 5) applied secondly to sustain electrodes SU1-SUn in the sustain period and the fifth sustain pulse (shown by p=5 in FIG. 5) applied thirdly to scan electrodes SC1-SCn in the sustain period following the fourth sustain pulse in the sustain period is second sustain pulse B. Furthermore, similarly, the tenth sustain pulse (not shown) applied fifthly to sustain electrodes SU1-SUn in the sustain period, and the eleventh sustain pulse (not shown) applied sixthly to scan electrodes SC1-SCn in the sustain period following the tenth sustain pulse in the sustain period are second sustain pulse B.

FIG. 5C is a view showing another example of sustain pulses applied to scan electrodes SC1-SCn and sustain electrodes SU1-SUn in the sustain period in accordance with the first exemplary embodiment of the present invention. For example, as shown in FIG. 5C, the third sustain pulse (shown by p=3) applied secondly to scan electrodes SC1-SCn in the sustain period and the subsequent fourth sustain pulse (shown by p=4) applied secondly to sustain electrodes SU1-SUn in the sustain period may be second sustain pulse B. In this example, the fifth sustain pulse (shown by p=5) applied thirdly to scan electrodes SC1-SCn in the sustain period is first sustain pulse A. Furthermore, the subsequent sixth sustain pulse (shown by p=6) applied thirdly to sustain electrodes SU1-SUn in the sustain period is first sustain pulse A. Then, the seventh sustain pulse in the sustain period (shown by p=7) is first sustain pulse A. Furthermore, the eighth sustain pulse in the sustain period (shown by p=8) is first sustain pulse B.

Since then, second sustain pulse B (shown by p=9), second sustain pulse B (not shown), first sustain pulse A (not shown), first sustain pulse A (not shown), second sustain pulse B (not shown), first sustain pulse A (not shown), . . . , are continued. In this way, two continuous sustain pulses excluding two continuous second sustain pulses B among four continuous sustain pulses in the above-mentioned sustain period may be first sustain pulse A. Such a driving method can reduce an after-image phenomenon itself and make the display brightness of discharge cells uniform.

FIG. 5D is a view showing a further example of sustain pulses applied to scan electrodes SC1-SCn and sustain electrodes SU1-SUn in the sustain period in accordance with the first exemplary embodiment of the present invention. As shown in FIG. 5D, the fifth sustain pulse (shown by P=5) applied thirdly to scan electrodes SC1-SCn in the sustain period and the subsequent sixth sustain pulse (shown by p=6) applied thirdly to sustain electrodes SU1-SUn in the sustain period may be second sustain pulse B. In this example, third sustain pulse applied secondly to scan electrodes SC1-SCn in the sustain period (shown by p=3) is gently rising first sustain pulse A. Furthermore, the fourth sustain pulse applied secondly to sustain electrodes SU1-SUn in the sustain period (shown by p=4) is steeply rising first sustain pulse A. Then, the seventh sustain pulse (shown by p=7) in the sustain period is first sustain pulse A. Furthermore, the eighth sustain pulse of the sustain period (shown by p=8) is second sustain pulse B.

Since then, first sustain pulse A (shown by p=9), first sustain pulse A (not shown), second sustain pulse B (not shown), second sustain pulse B (not shown), first sustain pulse A (not shown), second sustain pulse B (not shown) , . . . , are continued.

As shown in FIGS. 5B and 5D, the driving method of panel 10 in this exemplary embodiment is further characterized in that the sustain pulse (shown by p=5) applied thirdly to scan electrodes SC1-SCn in the sustain period is the second sustain pulse. In this case, as mentioned above, since at least one of the fourth sustain pulse (shown by p=4) applied secondly to sustain electrodes SU1-SUn in the sustain period and the sixth sustain pulse (shown by p=6) applied thirdly to sustain electrodes SU1-SUn in the sustain period is second sustain pulse B, two second sustain pulses B are continuously applied. Such a driving method can also reduce an after-image phenomenon itself and the brightness of discharge cells can be made uniform.

### Second Exemplary Embodiment

The second exemplary embodiment is different from the first exemplary embodiment in that a predetermined number of sustain pulses counted from the end of the sustain period are assumed to be a gently rising sustain pulse.

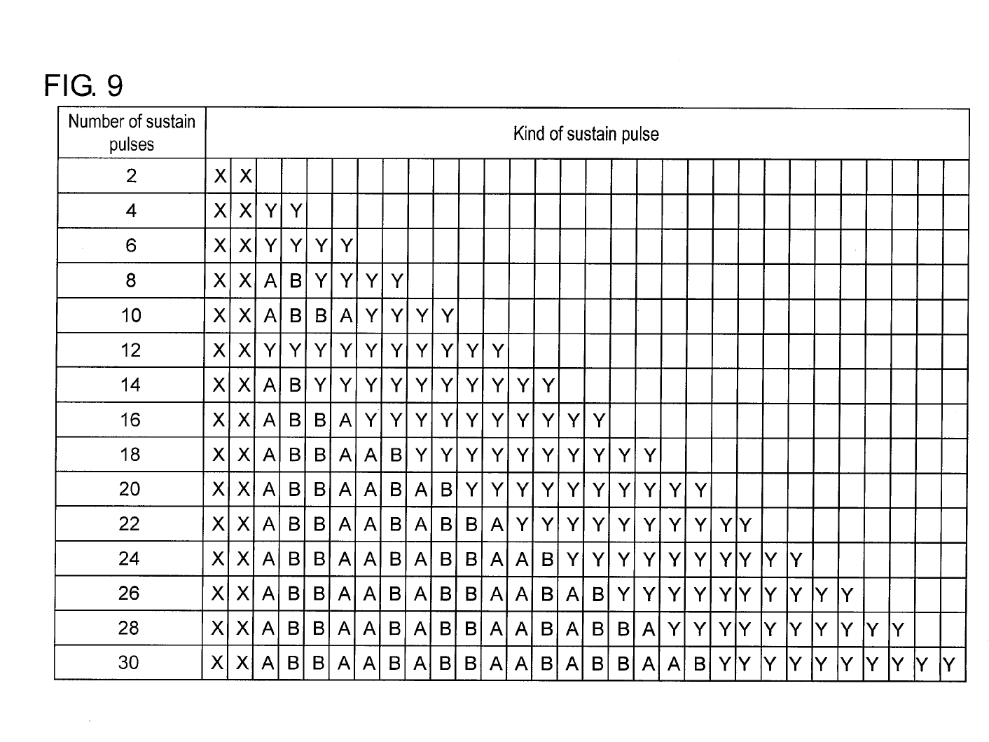

FIG. 9 is a view showing an example of sustain pulses applied to scan electrodes SC1-SCn and sustain electrodes SU1-SUn in the sustain period in accordance with a second exemplary embodiment of the present invention. FIG. 9 shows a sustain pulses in the case where the number of the sustain pulses in the sustain period in one subfield is “2” to “30.” First sustain pulse A is denoted by “A” and second sustain pulse B is denoted by “B.” Furthermore, in FIG. 5A, a pulse having a long pulse sustaining time described as “first sustain pulse” or “second sustain pulse” is denoted by “X” as the first sustain pulse and second sustain pulse in the sustain period and predetermined number of sustain pulses counted from the end is denoted by “Y.” For example, sustain pulse Y may have the same shape as that of first sustain pulse A and that of sustain pulse X. FIG. 9 shows an example in which when the number of sustain pulses is 10 or less, four sustain pulses counted from the end in the sustain period are rising sustain pulse Y and when the number of sustain pulses is 12 or more, ten sustain pulses counted from the end in the sustain period are sustain pulse Y. That is to say, in the driving method of panel 10 in this exemplary embodiment, second sustain pulse B is applied excluding a predetermined number of sustain pulses in the sustain period. In this exemplary embodiment, the predetermined number is made to be 4 or 10. However, the number is not limited to these alone.

In this way, when a predetermined number of sustain pulses counted from the end in the sustain period are assumed to be gently rising sustain pulses Y, a narrow-width pulse-like electric potential difference can be given to the display electrode pair, thereby erasing discharge for erasing a wall voltage on scan electrode SCi and sustain electrode SUi can be stabilized. Furthermore, the quality of image display can be improved.

Furthermore, FIG. 9 shows an example in which a sustain period is driven so that two continuous second sustain pulses B and two continuous first sustain pulses A are continuously applied to scan electrodes SC1-SCn and sustain electrodes SU1-SUn, sequentially. In this exemplary embodiment, one example is “B,” “B,” “A,” and “A” starting from the fourth sustain pulse in the sustain period shown in the row showing the number of sustain pulses of “18”. Furthermore, another example is “B,” “B,” “A,” and “A” starting from the fourth sustain pulse in the sustain period shown in the row showing the number of sustain pulses of “26”. A further example is “B,” “B,” “A,” and “A” starting from the tenth sustain pulse in the sustain period shown in the row showing the number of sustain pulses of “26”. This can reduce the after-image phenomenon itself and the display brightness of the discharge cells can be made uniform.

Furthermore, as shown in FIG. 5D, the sustain period may be driven to be “A,” “A,” “B,” and “B” starting from the third and ninth sustain pulses in the sustain period. That is to say, in the driving method of panel 10 in this exemplary embodiment, two continuous sustain pulses of the four continuous sustain pulses from the p-th (p denotes an integer of 3 or more) sustain pulse to the (p+3)-th sustain pulse may be second sustain pulse B sequentially applied to scan electrodes SC1-SCn and sustain electrodes SU1-SUn. In addition, two continuous sustain pulses excluding two continuous second sustain pulse B in the above-mentioned four continuous sustain pulses may be first sustain pulse A. In this way, even when the sustain period is driven so that two continuous first sustain pulses A and two continuous second sustain pulses B are sequentially applied to scan electrodes SC1-SCn and sustain electrodes SU1-SUn, the same effect as mentioned above can be obtained. Note here that any of two continuous first sustain pulses A or two continuous second sustain pulses B may be applied first.

This exemplary embodiment describes a configuration in which first sustain pulse A is set to be shorter than ½ of the resonance cycle and second sustain pulse B is set to be further shorter than this. The present invention is not necessarily limited to this configuration. For example, second sustain pulse B may be set to be shorter than ½ of the resonance cycle and first sustain pulse A may be set to be longer than ½ of the resonance cycle. Furthermore, according to APL of an image signal or a temperature of a panel and the like, a pulse sustaining time or a falling time may be made variable.

Furthermore, each of the specific values used in this exemplary embodiment is just an example and it is desired to be set to suitable values corresponding to the property of a panel or the specification of a plasma display device, and the like.

### INDUSTRIAL APPLICABILITY

According to the present invention, since it is possible to reduce an after-image phenomenon itself while a faithful image is displayed and to make display brightness of discharge cells uniform, the present invention is useful as a method for driving a panel.

1. A method for driving a plasma display panel including a plurality of discharge cells each having a scan electrode and a sustain electrode;
wherein one field includes a plurality of subfields each having an address period for generating address discharge in a discharge cell, and a sustain period for alternately applying a sustain pulse to the scan electrode and the sustain electrode to generate sustain discharge in the discharge cell in which the address discharge has been generated,
the sustain pulse includes a first sustain pulse rising gently and a second sustain pulse rising more steeply than the first sustain pulse, and
at least one of a sustain pulse applied secondly to the scan electrode and a sustain pulse applied thirdly to the scan electrode is the second sustain pulse, and at least one of a sustain pulse applied secondly to the sustain electrode and a sustain pulse applied thirdly to the sustain electrode is the second sustain pulse.

2. The method for driving a plasma display panel of claim 1, wherein the sustain pulse applied thirdly to the scan electrode is the second sustain pulse.

3. The method for driving a plasma display panel of claim 1, wherein the sustain pulse applied secondly to the scan electrode and the sustain pulse applied secondly to the sustain electrode are the second sustain pulse.

4. The method for driving a plasma display panel of claim 1, wherein the second sustain pulse is applied, excluding a predetermined number of sustain pulses from an end of the sustain period.

5. The method for driving a plasma display panel of claim 1, wherein two continuous sustain pulses among four continuous sustain pulses from a p-th sustain pulse (p is an integer of 3 or more) to a (p+3)-th sustain pulse in the sustain period sequentially applied to the scan electrode and the sustain electrode are the second sustain pulse.

6. The method for driving a plasma display panel of claim 5, wherein two continuous sustain pulses excluding the two continuous second sustain pulses are the first sustain pulses.
